(19) United States
(12) Patent Application Publication
(10) Pub. No.: US 2008/0127160 A1
(43) Pub. Date: May 29, 2008

(54) Removable card system for electronic components

(76) Inventors: Mark Henry Rackin, Smyrna, GA (US); Hakan Kostepen, Peachtree City, GA (US)

Correspondence Address: PANASONIC AUTOMOTIVE SYSTEM;COMPANY OF AMERICA, 776 HWY 74 SOUTH, PEACHTREE CITY, GA, 30269, US

(21) Appl. No.: 11/581,198

(22) Filed: Oct. 13, 2006

(51) Int. Cl. G06F 9/44

(52) U.S. Cl. 717/168

(57) ABSTRACT

An electronic system includes an electronic apparatus having a port with a restricted-access feature. A writeable memory device is removeably connected to the port. The memory device updateably stores operating software for the electronic apparatus.

### BACKGROUND OF THE INVENTION

1. Field of the Invention

The present invention relates generally to electronic systems including memory devices and other types of components, and, more particularly, to a modular system of such electronic components.

2. Description of the Related Art

Operating software is system software that supervises and directs most or all of the other software components of an electronic system, such as an entertainment system or a computer, for example. The operating software may also supervise and direct the computer hardware that is associated with the electronic system. Thus, the operating software may define the functionality of the electronic system.

There are several known methods of storing operating software in electronic systems. In one method, the operating software is stored in either internal permanent electronic memory, such as read-only memory (ROM), or internal semi-permanent electronic memory, such as flash read-only memory (Flash ROM), both of which are stored within the interior of the electronic system's housing. In another method, the operating software is stored on a hard disk drive (HDD), which is stored in the interior of the electronic system's housing. Obtaining access to these operating software storage devices may be a cumbersome task and may expose other internal components to risk of damage. In addition to operating software, digital content may also be stored internally on Flash ROM or HDD. Such digital content may include data files in the case of a computer, and audio and/or video files in the case of an entertainment system.

There are, however, several drawbacks associated with the use of a HDD for storage of operating software and digital content. HDDs consume relatively high levels of power, can be acoustically noisy, and may be susceptible to damage from environmental factors that do not affect other forms of electronic memory nearly as severely. Such environmental factors include temperature extremes, shock and vibration, and high altitude, for example. HDDs also have the disadvantage of not being very scalable in terms of the amount of memory that is provided versus cost. That is, the cost of the basic mechanism is a very large percentage of the total cost, and the variable cost of memory capacity is a much lower percentage of the total cost. Thus, HDDs may not be economically suitable for applications wherein only a relatively small amount of memory is required.

Difficulty of upgrading is a problem that is associated with both HDDs and Flash ROMs. The ability to upgrade and add features is particularly important to original equipment manufacturers (OEMs) in the automotive entertainment electronics industry. The long development cycles of automobile models make it nearly impossible to anticipate what technologies, media and content formats, etc. will be prevalent at the time that the cars are offered for sale. Development costs and logistical limitations of current storage technology make it difficult to provide upgrades between “refreshes” of a vehicle model when the technologies, media and/or content formats change.

In order to upgrade an HDD-based system, another mechanism such as a compact disc (CD) or digital versatile disc (DVD) is required at additional cost. Some systems that use internal Flash ROM for program storage are theoretically upgradeable, but upgrades require some additional mechanism for inputting the new software into the system. Moreover, there is a risk of destroying the Flash ROM-based system if anything disrupts the upgrade process before it is completed.

Another problem is associated with the use of HDDs and Flash ROMs for the storage of digital content. Because the storage capacities of HDDs and Flash ROMs are fixed, the manufacturer must anticipate and estimate how much memory will be desired by consumers for the storage of digital content. Of course, consumer preferences vary, and the amount of memory provided by the manufacturer for the storage of digital content is often either much greater or much less than what is desired by a particular consumer.

Other components that define the functionality of an electronic system, particularly an automotive entertainment system, or “infotainment” system, may also be difficult to upgrade. Such components may include universal serial bus (USB) interfaces, global positioning system (GPS) sensors, GPS navigation engines, Bluetooth compatible devices, cameras, wireless fidelity (Wi-Fi) compatible devices, and AM/FM radio receivers, to name a few.

The functionality-defining components may be difficult to upgrade due to the permanent nature of their connections to the system. That is, the components may be soldered to other connectors or components of the system, or may otherwise be permanently attached to other connectors or components of the system. The components may also be difficult to upgrade due to incompatibility in the type of connectors employed in the original component and in the upgraded component. For example, the original component may have a different number of terminals or conductors than does the upgraded component. Consequently, it may be difficult or impossible to connect the upgraded component to the connectors or components of the system that were previously connected to the original component. In the case of an automotive infotainment system, upgrading a component may require costly upgrading of other connectors or components of the system so that they may be able to be connected to the upgraded component.

What is needed in the art is a system for storing operating software that allows the operating software to be easily upgraded. What is also needed is a system for storing operating software and digital content that avoids the disadvantages of the prior art discussed above. What is further needed is an automotive infotainment system that accommodates upgrading of its functionality-defining components without requiring corresponding upgrades to other components or connectors that are to be connected to the upgraded functionality-defining components.

### SUMMARY OF THE INVENTION

The present invention is directed to an electronic system including a memory arrangement that may be conveniently and efficiently updated or “refreshed.” In one aspect, the operating software and digital content are stored on separate memory devices. These memory devices may be easily removed from and engaged with the components of the electronic system. In a further aspect, the memory arrangement may be adapted such that the digital content memory device may be replaced by the consumer or end user of the electronics. Access to the operating software memory device may be restricted, e.g., may require a special tool and/or electronic access code, such that the operating software may only be changed or upgraded by personnel who are approved by the provider of the electronics, such as employed or certified vehicle technicians. When applied to the case of an automotive entertainment system, the present invention enables memory devices and other functionality-defining components to be easily upgraded by the consumer and/or by a technician without requiring entry into the interior of the electronic system housing, or upgrades in or replacement of connectors or other components that are to be connected to the upgraded components.

The invention comprises, in one embodiment thereof, an electronic system including an electronic apparatus having a port with a restricted-access feature. A writeable memory device is removeably connected to the port. The memory device updateably stores operating software for the electronic apparatus.

The invention comprises, in another embodiment thereof, a method of updating operating software of an electronic system, including providing an electronic apparatus having a port with a lock-out feature. A first memory device is connected to the port. The memory device stores first operating software for the electronic apparatus. The lock-out feature is unlocked, and the memory device is disconnected from the port. A second memory device is connected to the port. The second memory device stores second operating software for the electronic apparatus. The lock-out feature is locked.

The invention comprises, in yet another embodiment thereof, an automotive audio head unit including a first electrical port in communication with the processor. A first writeable memory storage medium is electrically coupled to the port. The storage medium stores operating software for the head unit. The storage medium is physically inaccessible to a consumer of the head unit. The storage medium is accessible to, and replaceable by, a serviceman for upgrading the operating software. A second electrical port is in communication with the processor. A second writeable memory storage medium is removeably coupled to the second port. The second storage medium stores audio content for playback by the head unit. The second storage medium is replaceable by the consumer of the head unit. The second storage medium is physically interchangeable with the first storage medium.

The invention comprises, in a further embodiment thereof, an automotive infotainment system including an electronic device in communication with an audio/video head unit and having at least one first terminal. The device defines a functionality of the audio/video head unit. A connector has at least one second terminal. Each second terminal is electrically connected to a corresponding first terminal. The connector electrically connects the device to the system such that the device may be gripped and disconnected from the connector by pulling the device in a first single direction. An upgraded version of the device may be subsequently connected to the connector by pushing the upgraded version of the device in a second single direction. The second single direction is substantially opposite to the first single direction.

The invention comprises, in a still further embodiment thereof, an electronic system for installation in a vehicle and for use in the vehicle by a vehicle end user. The electronic system includes an audio head having a housing and processor disposed within the housing. A first memory device port is disposed on the housing and is electrically coupled to the processor. The first memory device port is accessible from an exterior of the housing when the electronic system is uninstalled from the vehicle. The first memory device port is inaccessible by the end user when the electronic system is installed in the vehicle. A first memory device is removably coupled with the first memory device port. The first memory device stores operating software for the operation of the processor.

An advantage of the present invention is that the operating software of an electronic apparatus may be easily updated by authorized personnel.

Another advantage is that lock-out features may be provided to prevent unauthorized personnel from modifying the operating software.

Yet another advantage is that the same type of storage medium that is used to store the operating software may also be used by the consumer to store and provide digital content for playback by the electronic apparatus.

Still another advantage is that the operating software may be retrieved from the storage medium at low power levels, in an acoustically quiet manner, and under a wide range of environmental conditions.

A further advantage is that any device that defines the functionality of an automotive audio/video head unit may be easily removed from the automotive infotainment system and replaced with an upgraded version of the device.

A still further advantage is that lock-out features may be provided to prevent unauthorized personnel from modifying or adding electronic devices within an automotive infotainment system.

### BRIEF DESCRIPTION OF THE DRAWINGS

The above-mentioned and other features and advantages of the invention will become more apparent to one with skill in the art upon examination of the following figures and detailed description. The components in the figures are not necessarily to scale, emphasis instead being placed upon illustrating the principles of the invention. Moreover, in the figures, like reference numerals designate corresponding parts throughout the different views.

FIG. 1 is a block diagram of one embodiment of an electronic system of the present invention.

FIG. 2 is a front perspective view of a particular implementation of the electronic system of FIG. 1 in the form of an automotive audio head unit.

FIG. 3 is a rear perspective view of the automotive audio head unit of FIG. 2.

FIG. 4 is a block diagram of the automotive audio head unit of FIG. 2.

FIG. 5 is a flow chart of one embodiment of a method of the present invention for updating operating software of an electronic system.

FIG. 6 is a block diagram of one embodiment of an automotive infotainment system of the present invention.

FIG. 7 is a perspective view of one embodiment of an electronic device and connector of the automotive infotainment system of FIG. 6.

### DETAILED DESCRIPTION OF THE PRESENTLY PREFERRED EMBODIMENTS

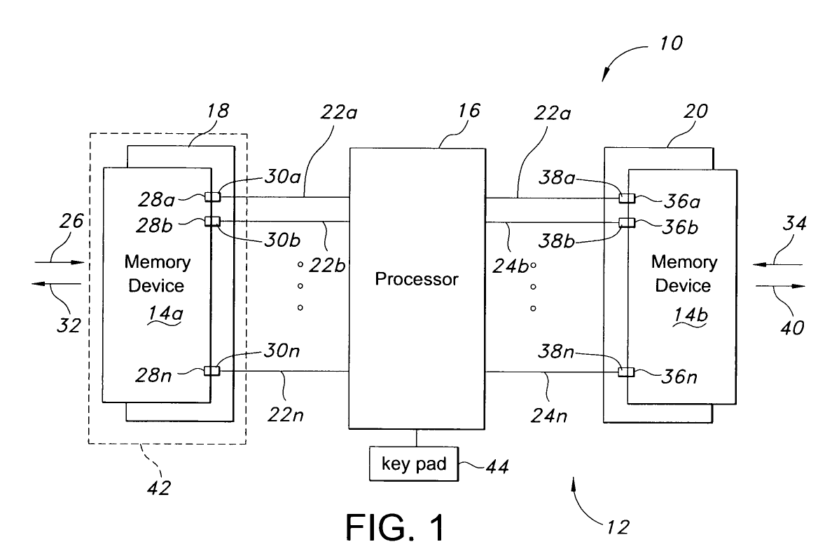

Referring to FIG. 1, there is shown one embodiment of an electronic system 10 of the present invention including an electronic apparatus 12 and memory devices 14a, 14b. Electronic apparatus 12 may include a processor 16 in electrical communication with electrical ports 18 and 20. Processor 16 may be in the form of a microprocessor, for example, and may include additional processing and/or interface circuitry. Processor 16 is shown as being connected to ports 18, 20 via respective parallel data lines 22a, 22b, . . . , 22n and 24a, 24b, . . . , 24n. However, it is also possible for processor 16 to be connected to ports 18, 20 via serial data lines. Moreover, it is within the scope of the invention for ports 18, 20 to be connected to processor 16 via optical links, such as infra-red links, or any other data transmission arrangement capable of transmitting data between processor 16 and ports 18, 20.

Port 18 interfaces with memory device 14a such that the contents of memory device 14a may be read by processor 16 when memory device 14a is received in port 18. The interface between memory 14a and port 18 may be in any suitable form including, for example, an electronic, magnetic or optical interface. Similarly, port 20 interfaces with memory device 14b such that the contents of memory device 14b may be read by processor 16 when memory device 14b is received in port 20. The interface between memory 14b and port 20 may be in any suitable form including, for example, an electronic, magnetic or optical interface.

Memory devices 14a, 14b may be writeable in the sense that it is possible for their contents to be overwritten by a consumer of electronic apparatus 12 or by service personnel. Each of memory devices 14a, 14b may be latched into, and unlatched from, respective ports 18, 20 by use of respective push-push type latching mechanisms (not shown). Such push-push latches are well known in the art and are spring-loaded for latching and unlatching storage devices such as cassette tapes and 3.5 inch floppy discs, for example.

By virtue of the push-push latches, memory devices 14a, 14b may be inserted into respective ports 18, 20 in a single linear manual actuation. That is, memory device 14a may be inserted into port 18 and electrically connected to port 18 by manually moving device 14a in a single motion in linear direction 26 into port 18 until memory device 14a is latched therein. More particularly, after device 14a “bottoms”, manual pressure is released by the user. This leaves device 14a securely locked into port 18, maintaining electrical and mechanical integrity despite the shocks and vibrations to which apparatus 12 may be subjected. Of course, as discussed in further detail below, any mechanism may be used to receive and hold memory devices 14a, 14b in ports 18, 20.

Memory device 14a may include electrical contacts 28a, 28b, . . . , 28n that electrically connect with corresponding electrical contacts 30a, 30b, . . . , 30n of port 18 when device 14a is inserted into port 18. Memory device 14a may be removed from and electrically disconnected from port 18 in a single manual actuation. Particularly, device 14a may be removed from and electrically disconnected from port 18 by again manually pushing on an exposed end of device 14a in direction 26 until device 14a becomes unlatched, i.e., disengaged from the latch, and is pushed away, or partially ejected, from port 18 by a spring of the push-push latch in a direction 32 that is substantially opposite to direction 26. Device 14a may be then manually gripped by the user and removed from port 18.

Similarly to memory device 14a, memory device 14b may be inserted into port 20 and electrically connected to port 20 by manually moving device 14b in a single motion in linear direction 34 into port 20 until memory device 14b is latched therein. More particularly, after device 14b “bottoms”, manual pressure is released by the user. This leaves device 14b securely locked into port 20, maintaining electrical and mechanical integrity despite the shocks and vibrations to which apparatus 12 may be subjected.

Memory device 14b may include electrical contacts 36a, 36b, . . . , 36n that electrically connect with corresponding electrical contacts 38a, 38b, . . . , 38n of port 20 when device 14b is inserted into port 20. Memory device 14b may be removed from and electrically disconnected from port 20 in a single manual actuation. Particularly, device 14b may be removed from and electrically disconnected from port 20 by again manually pushing on an exposed end of device 14b in direction 34 until device 14b becomes unlatched, i.e., disengaged from the latch, and is pushed away, or partially ejected, from port 20 by a spring of the push-push latch in a direction 40 that is substantially opposite to direction 34. Device 14b may be then manually gripped by the user and removed from port 20.

Corresponding pairs of contacts 28 and 30 may be biased together in electrical contact with each other. For example, contacts 28 and/or contacts 30 may be provided with a resilient structure such that corresponding pairs of contacts 28 and 30 are biased against each other. Thus, pairs of contacts 28, 30 may be maintained in electrical contact without any bonding being provided between contacts 28, 30. That is, electrical conductivity may be provided between pairs of contacts 28, 30 without there being any soldering or any other type of chemical bonding between contacts 28 and contacts 30.

Memory devices 14a, 14b may store different data, and the data stored by memory devices 14a, 14b may be of different types. For example, in one embodiment, memory device 14a stores operating software for electronic apparatus 12, and memory device 14b stores digital content to be played back by apparatus 12 in audio form, video form, or in the form of an interactive game, for example.

The operating software stored in memory device 14a may define the features, capabilities, or operation of electronic apparatus 12. It is possible that different capabilities, or different levels of capabilities, of electronic apparatus 12 may be offered to a consumer of apparatus 12 for different levels of monetary payment by the consumer. Thus, a consumer of apparatus 12 may select certain features, or a certain level of features, of apparatus 12 that he is willing to pay for. A memory device 14a that stores operating software that corresponds to or enables the features selected by the consumer may be inserted into port 18 for use by processor 16. If a memory device 14a that is currently received in port 18 does not contain the operating software that is appropriate for the requested features, then device 14a may be removed from port 18, the appropriate updated operating software may be written onto device 14a, and the newly overwritten device 14a may be reinserted into, and reconnected to, port 18 to thereby upgrade the operating software of apparatus 12.

The digital content stored in memory device 14b may include text files, audio files such as music or spoken words, video files such as digital photographs, or files that are a combination of audio and video content, such as cinematic motion pictures. Memory device 14b may also include digital content that is accessed interactively by the consumer via processor 16. Examples of such interactively accessed digital content include video games and digitized navigation maps.

Although memory devices 14a, 14b may store different sets of data, and different types of data, memory devices 14a, 14b may be physically similar or substantially identical such that devices 14a, 14b are physically interchangeable. That is, memory devices 14a, 14b may have the same physical dimensions, may have the same number of electrical contacts, and their electrical contacts may be disposed at the same locations on their respective bodies. Thus, it may be possible for memory device 14a to be inserted into and electrically connected to port 20, and for memory device 14b to be inserted into and electrically connected to port 18. Because memory device 14b typically does not include operating software, it may not be desirable for memory device 14b to be inserted into port 18. Thus, according to the present invention, port 18 may be provided with a lock-out feature 42 to prevent a consumer from inadvertently placing into port 18 a memory device that does not contain valid operating software.

Lock-out feature 42, which is schematically indicated by a dashed block in FIG. 1, may restrict access to memory device 14a and/or port 18 by a consumer of electronic apparatus 12. More particularly, lock-out feature 42 may function to prevent a consumer of electronic apparatus 12 from accessing memory device 14a and/or port 18, but may also function to allow an authorized person to have access to memory device 14a and/or port 18. An example of an authorized person is a serviceman acting as an agent of a manufacturer, distributor or marketer of electronic apparatus 12.

By the consumer being locked out of, i.e., denied access to, memory device 14a and/or port 18, the consumer may be prevented from removing device 14a and updating the operating software without paying corresponding fees. For example, if the consumer were to gain access to memory device 14a, he may be able to remove device 14a from port 18 and overwrite device 14a with more expensive and/or updated operating software. Alternatively, if the consumer were to gain access to memory device 14a, he may be able to replace device 14a with another memory device 14a that contains “bootleg” updated software that was distributed without permission of the owner of the software. Another potential hazard associated with the consumer gaining access to memory device 14a and/or port 18 is that the consumer may inadvertently replace or overwrite device 14a such that no valid operating software is available in port 18, thereby causing electronic apparatus 12 to be inoperable.

Lock-out feature 42 may be in mechanical form and/or in electrical form. As an example of a mechanical form of lock-out feature 42, port 18 and memory device 14a may be physically inaccessible to a consumer of apparatus 12. The inaccessibility of port 18 and memory device 14a may be due to port 18 and memory device 14a being disposed or hidden within an outer shell or cover (not shown), which may be attached to the housing of apparatus 12. A specialized tool may be required to at least partially disassemble the shell to thereby gain access to port 18 and memory device 14a. Alternatively, port 18 and memory device 14a may be inaccessible due to apparatus 12 being disposed within another piece of equipment such that port 18 and memory device 14a are covered by the piece of equipment or are otherwise unexposed. For instance, as discussed in further detail below, port 18 may be located on a portion of apparatus 12 that is positioned behind the dashboard of a vehicle when apparatus 12 is installed in the vehicle. In this case, port 18 is inaccessible by the consumer.

As an example of an electrical form of lock-out feature 42, processor 16 may require the entry of an electronic access code before processor 16 will accept an updated version of the operating software. For example, an access code that is particular to processor 16 may be entered via a keypad 44. It is also possible for processor 16 to receive an access code via wireless internet or some other wireless medium. As another alternative, an updated memory device 14a may include an electronic access code that may be read by processor 16.

Electronic apparatus 12 may be in the form of any of various appliances for entertainment or other purposes. Examples of types of electronic apparatus that may be suitable as apparatus 12 of the present invention may include audio devices, video devices, devices that have both audio and video features, personal computers, and interactive devices, such as video games and electronic navigation equipment. Examples of audio devices suitable as apparatus 12 may include an audio receiver, a compact disc player, a digital audio player, or a vehicle audio head unit, such as for use in an automobile, truck, boat, airplane, recreational vehicle or other vehicle. Examples of video devices suitable as apparatus 12 may include a television, a monitor, or a DVD player, for example.

Memory devices 14a, 14b may be in the form of any digital memory device that can be easily inserted into one of the ports 18, 20, read by processor 16, and removed from the port in which the memory device was inserted. In one embodiment, one or both of memory devices 14a, 14b may be overwritten to change the content of the memory device. That is, one or both of memory devices 14a, 14b may be writeable memory devices. In one embodiment, one or both of memory devices 14a, 14b has a mechanical lock that can be selectively set to prevent the contents of the memory device from being overwritten.

Memory devices 14a, 14b are shown in FIG. 1 as having electrical contacts 28, 36 that physically engage corresponding electrical contacts 30, 38 of respective ports. However, it is to be understood that it is within the scope of the present invention for memory devices 14a, 14b to be read by apparatus 12 by optical or magnetic techniques that do not rely upon physical engagement of the memory devices for the reading of the memory device. For example, it is possible for one or both of memory devices 14a, 14b to be read optically in the manner of a compact disc or DVD. It is also possible to read magnetic fields produced by memory devices 14a, 14b to thereby read the data, e.g., operating software and/or digital content, stored on the memory devices.

In one embodiment, memory devices 14a, 14b are in the form of secure digital memory cards, commonly known as “SD memory cards”. In other embodiments, memory devices 14a, 14b may be in the form of SDIO (secure digital input/output) cards, USB flash drives, compact flash cards, or memory sticks, for example.

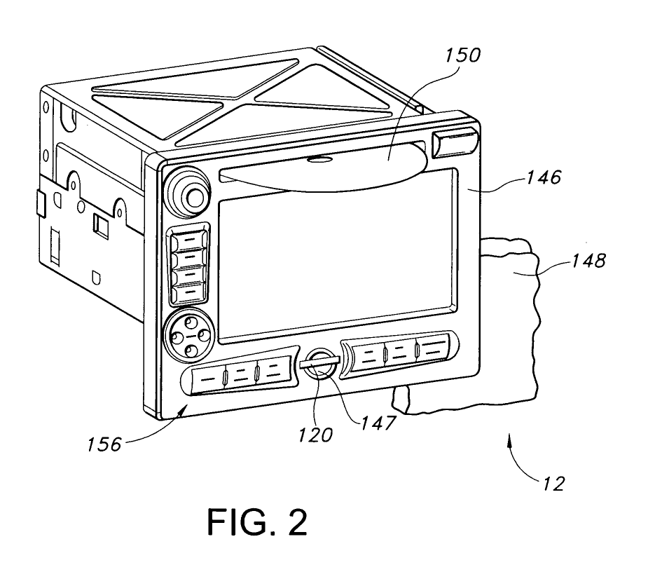

A specific embodiment of an electronic apparatus of the present invention in the form of an automotive audio head unit 112 is shown in FIG. 2. Head unit 112 includes a front face or face plate 146 having a port 120 in the form of a recessed slot for receiving a memory device (not shown) such as a secure digital (SD) memory card. A central portion of port 120 is disposed within a frustospherical indentation 147 which accommodates the actuation of a memory device within port 120 by a user's finger. As can be seen in FIG. 2, the front face and port 120 are freely exposed and accessible to a consumer of head unit 112, even when head unit 112 is installed in a dashboard 148, which is only fragmentarily depicted in FIG. 2. By virtue of its easy accessibility to the consumer, port 120 does not include any mechanical lock-out feature. Further, in this embodiment, apparatus 112 does not provide an access code or any other type of electronic lock-out feature for port 120. Thus, port 120 may be suitable for receiving a consumer-provided memory device that stores digital content. In view of the electronic apparatus being in the form of an automotive audio head unit in this embodiment, any memory device that is inserted into port 120 may typically contain music files that the consumer has transferred to the memory device by downloading via a personal computer from the internet or some other source of music files. The music files may be electronically received from an on-line retailer, for example. It is also possible that the consumer may purchase a memory device that contains music files, and that is to be inserted into port 120, from a retail outlet. Further, the music files may be created by the consumer from other media content that he has access to, e.g., ripping from a compact disc or other medium, or may be recorded live by the consumer.

Head unit 112 may also include a compact disc (CD) player for playing a compact disc 150 that may be loaded into head unit 112 through face plate 146 as shown. Thus, head unit 112 may be a “dual playback” type of head unit.

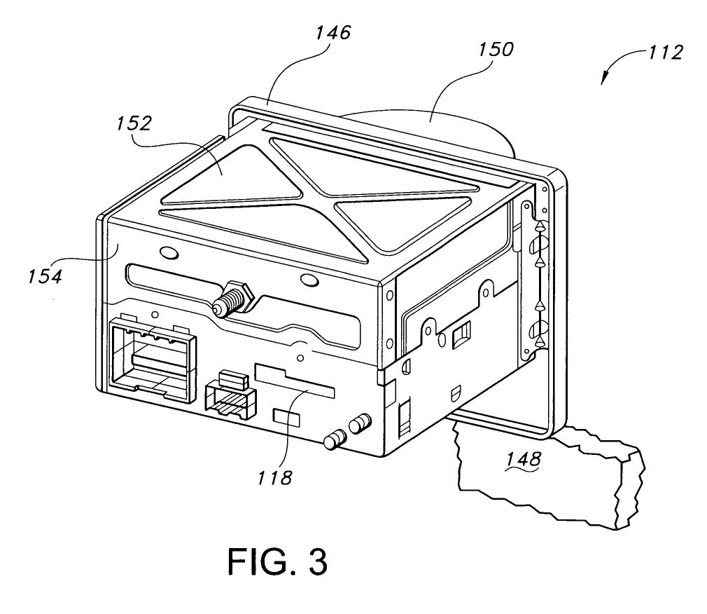

As shown in FIG. 3, head unit 112 may include a housing 152 having an interior space (not shown) in which internal components of the electronic system, such as processor 16, may be housed. Housing 152 has a rear face 154 with a port 118 thereon for receiving another memory device (not shown) which also may be a secure digital (SD) memory card. Port 118 may be electrically coupled to processor 16 within housing 152. In the embodiment shown, port 118 is in the form of a recessed slot. Dashboard 148 is again only fragmentarily depicted in FIG. 3. As can be deduced from FIG. 3, port 118 is disposed behind dashboard 148 when head unit 112 is installed in dashboard 148, and thus port 118 is not accessible to a consumer of head unit 112. Specialized tools may be required to remove head unit 112 from dashboard 148. By virtue of it being inaccessible to the consumer, port 118 includes a mechanical lock-out feature that prevents a consumer from accessing, removing, or modifying a memory device that is received in port 118. Further, it is also possible for head unit 112 to provide an electronic lock-out feature to prevent head unit 112 from reading another memory device, or a modified memory device, should a consumer uninstall head unit 112 from dashboard 148 and remove the memory device from port 118. The electronic lock-out feature may be in the form of an access code that must be entered via pushbuttons 156 (FIG. 2) on faceplate 146 before head unit 112 may read a memory device that is inserted into port 118 after a memory device has been removed from port 118. Thus, port 118 may be suitable for receiving a manufacturer-provided memory device that stores operating software for head unit 112.

Head unit 112 may include various levels of features and options that may be set by the operating software. As one example, the consumer may elect whether head unit 112 is to receive satellite radio broadcasting.

If the consumer requests features or options that are not provided by the operating software that is stored in the memory device that is currently received in port 118, then authorized personnel, such as a serviceman, may gain access to port 118 and to the memory device received therein by circumventing or overcoming the mechanical and/or electronic lock-out features of port 118. For example, a serviceman may remove or uninstall head unit 112 from dashboard 148. After thus gaining access to rear face 154 and port 118, the serviceman may push on the exposed edge of the memory device and thereby cause the push-push latch to partially eject the memory device from port 118. The serviceman may then grip the memory device and pull the memory device entirely out of port 18. The serviceman may insert into port 118 another memory device that contains operating software that enables the features requested by the consumer. Alternatively, instead of inserting another memory device, the serviceman may take the memory device that was previously in port 118 and overwrite or reprogram the operating software with upgraded operating software that enables the requested features. The reprogramming of the memory device may require the use of a specially-configured computer. The serviceman may then reinsert the same memory device with the upgraded operating software into port 118. Additionally, the serviceman may need to enter an access code via pushbuttons 156 before head unit 112 will read the upgraded operating software on the memory device in port 118.

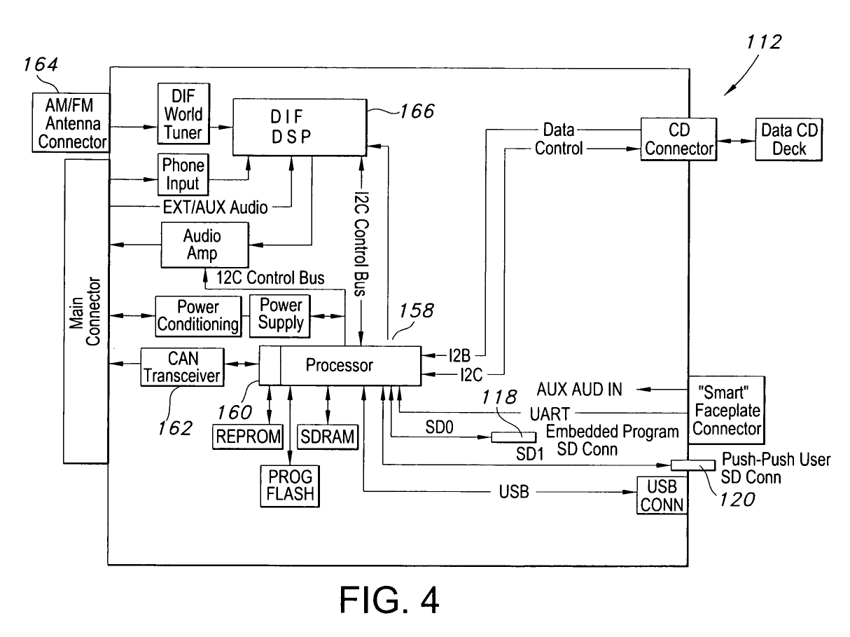

A block diagram of one example of the electronic circuitry of head unit 112 is shown in FIG. 4. A central processor 158 reads the contents of the memory devices in both ports 118 and 120. Processor 158 includes a Controller Area Network (CAN) bus interface 160 for interfacing with CAN transceiver 162. Air-borne radio signals received via AM/FM Antenna Connector 164 may be processed by a digital intermediate frequency (DIF) digital signal processor (DSP) 166.

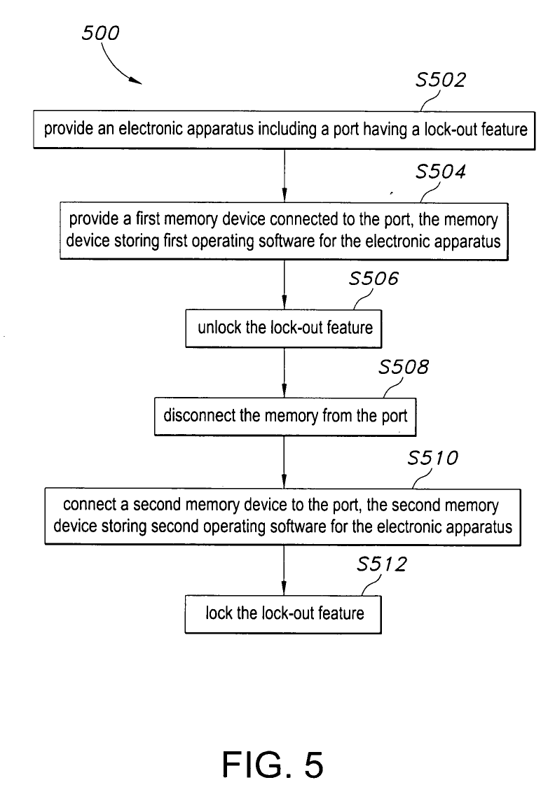

One embodiment of a method 500 of the present invention for updating operating software of an electronic system is shown in FIG. 5. In a first step S502, an electronic apparatus including a port having a lock-out feature is provided. For example, an apparatus in the form of an automotive audio head unit including a port 118 having a lock-out feature is provided. In an embodiment described above, the lock-out feature is in the form of port 118 being unexposed and inaccessible to a consumer when head unit 112 is installed within a dashboard. The lock-out feature may also include the requirement that an electronic access code be entered before a memory device can be inserted into port 118 and read by the processor. Next, in step S504, a first memory device connected to the port is provided. The memory device stores first operating software for the electronic apparatus. That is, an SD memory card may be disposed in and electrically connected to port 118. The SD memory card may store a first or initial version of operating software for head unit 112. In step S506, the lock-out feature is unlocked. For example, a serviceman may use a specialized tool to remove or uninstall head unit 112 from dashboard 148 such that port 118 is exposed. In addition, an electronic access code may be entered via pushbuttons 156 wherein the code enables the processor to read another memory device that is inserted in port 118 after the memory device that is presently in port 118 has been removed. In a next step S508, the memory device is disconnected from the port. That is, the serviceman may manually pull the SD memory card out of port 118 such that the SD memory card is electrically disconnected from port 118. Alternatively, the serviceman may use a specialized tool to pull the SD memory card out of port 118. In step S510, a second memory device is connected to the port. The second memory device stores second operating software for the electronic apparatus. The second memory device may be in the form of another SD memory card that stores updated operating software for head unit 112. Alternatively, the second memory device may be the same SD memory card that was pulled out of port 118, but with updated operating software having been overwritten onto the memory card. In a final step S512, the lock-out feature is locked. For example, head unit 112 may be assembled and reinstalled in dashboard 148 such that port 118 is again inaccessible and unexposed. An electronic lock-out feature may be locked in the sense that, once the processor has read the updated operating software on the memory device that was inserted into port 118 in step S510, the processor will not read another version of the operating software unless and until the same or another valid access code has been entered via pushbuttons 156.

The steps S506 through S512 may be performed in response to a consumer making a request for updated features or options of head unit 112. Alternatively, the desired features/options may be determined at an assembly plant or at an automobile dealership, and the appropriate operating software may be selected and written onto the memory device to be inserted into port 118.

The advantages of the present invention may be extended to devices other than memory devices within an automotive or vehicle environment. More particularly, a vehicle infotainment system may include several devices that each contributorily defines the functionality of the system. Such functionality-defining devices may include USB interfaces, GPS sensors, GPS navigation engines, Bluetooth compatible devices, cameras, Wi-Fi compatible devices, and AM/FM radio receivers, for example. The present invention may be extended to such functionality-defining devices to thereby enable the devices to be quickly and easily upgraded by authorized personnel. Further, the lockout features of the present invention may be extended to such functionality-defining devices to thereby prevent unauthorized personnel from modifying the devices or adding functionality that the user of the system did not pay for. For example, the lockout features may prevent a user from transferring a high-functionality device from vehicle to vehicle. The lockout features may be mechanical or electronic in form, as in the embodiments discussed above.

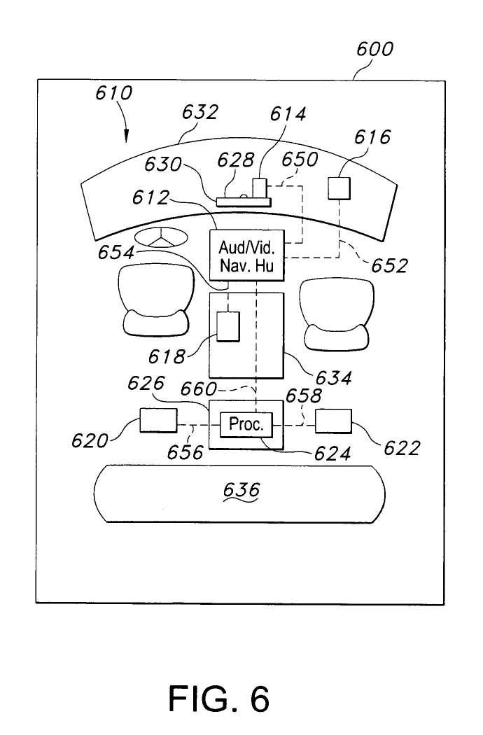

FIG. 6 illustrates one embodiment of an automobile 600 including an automotive infotainment system 610 of the present invention. System 610 includes an automotive audio/video head unit 612 that is in direct electronic communication with electronic devices 614, 616 and 618. Head unit 612 is in indirect electronic communication with electronic devices 620, 622 via a processor 624 of a rear seat entertainment module 626.

Head unit 612 may have audio and video playback capability, and may be capable of providing visual and/or audial navigation information. Head unit 612 may include any of the features of head unit 112 as well as additional features.

Electronic device 614 is shown as being mounted to a forward-facing surface 628 of a rearview mirror 630 such that device 614 has visibility to the sky through a front windshield 632 of automobile 600. Device 616 may be mounted on a dashboard of automobile 600 such that device 616 also has visibility to the sky through front windshield 632. Either of devices 614, 616 may be a GPS sensor that operates in conjunction with a navigation engine that displays a map on head unit 612. Either of devices 614, 616 could also be a wi-fi compatible device. Devices 614, 616 may include electronic or mechanical lockout features to prevent unauthorized modification or updating of devices 614, 616.

Device 618 may be mounted on a console 634 of automobile 600 such that a user of system 610 has access to device 618. Device 618 may be a Bluetooth compatible device or a wireless USB interface, for example. In one embodiment, device 618 does not include a lockout feature, and thus the user is able to modify or update device 618.

Rear seat entertainment module 626 may include one or more display monitors disposed above a rear seat 636 of automobile 600. In one embodiment, module 626 includes two display monitors each disposed proximate a respective opposite end of rear seat 636. Devices 620, 622 may individually define the functionality of a respective one of the display monitors, and thus of head unit 612, which controls the display monitors.

Each of devices 614, 616, 618, 620 and 622 may individually define a respective aspect of the functionality of head unit 612. That is, each of devices 614, 616, 618, 620 and 622 may individually define a feature or level of performance of head unit 612, for example. Each of devices 614, 616, 618, 620 and 622 may be in the form of a memory device, a universal serial bus interface, a global positioning system sensor, a global positioning system navigation engine, a Bluetooth compatible device, a camera, a wireless fidelity compatible device, or an AM/FM radio receiver, for example.

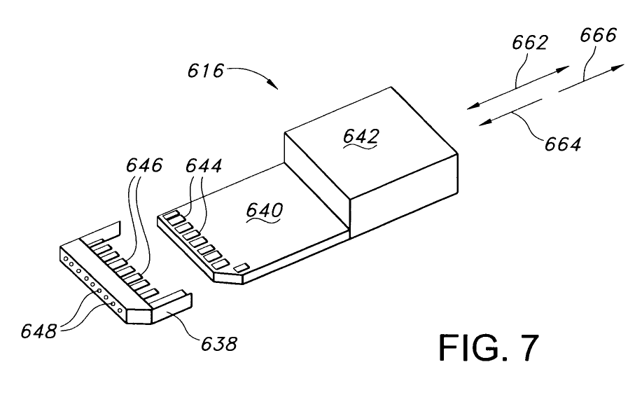

Each of devices 614, 616, 618, 620 and 622 may be connected to the remainder of system 610 via a respective electrical connector. FIG. 7 illustrates one embodiment of an electrical connector 638 that may be suitable for interconnecting any of the electronic devices to system 610. A specific embodiment of device 616 in the form of a GPS sensor is also schematically illustrated in FIG. 7.

In the illustrated embodiment, device 616 includes an electrical interface 640 that is in electronic communication with a body 642 of device 616. Interface 640 includes a plurality of electrically conductive pins or terminals 644 for engaging and thus being electrically connected with corresponding terminals 646 of connector 638. In the embodiment shown, interface 640 is in the form of a secure digital input/output (SDIO) interface, and connector 638 is in the form of an SDIO connector. Each of terminals 646 may have an exposed end 648 for electrical connection to a communication bus through which the electronic device is connected to the remainder of system 610. Referring to FIG. 6, devices 614, 616, 618 are connected to head unit 612 via communication buses 650, 652, 654, respectively, devices 620, 622 are connected to processor 624 via communication buses 656, 658, respectively, and processor 624 is connected to head unit 612 via communication bus 660.

Connector 638 may electrically connect device 616 to the system such that device 616 may be disconnected and removed from connector 638 exclusively by moving device 616 along a single axis 662, and such that an upgraded version of device 616 may be subsequently connected to connector 638 by pushing the upgraded version of device 616 along axis 662 and into engagement with connector 638.

Connector 638 may include a push-push type latching mechanism (not shown) by use of which device 616 may be latched into, and unlatched from, connector 638. By virtue of the push-push latch, device 616 may be inserted into connector 638 in a single linear manual actuation. That is, device 616 may be inserted into connector 638 and electrically connected to connector 638 by manually moving device 616 in a single motion in linear direction 664 into connector 638 until connector 638 is latched therein. More particularly, after device 616 “bottoms”, manual pressure is released by the user. This leaves device 616 securely locked into connector 638, maintaining electrical and mechanical integrity despite the shocks and vibrations to which system 610 may be subjected.

Device 616 may be removed from and electrically disconnected from connector 638 in a single manual actuation. Particularly, device 616 may be removed from and electrically disconnected from connector 638 by again manually pushing on an exposed end of device 616 in direction 664 until device 616 becomes unlatched, i.e., disengaged from the latch, and is pushed away, or partially ejected, from connector 638 by a spring of the push-push latch in a direction 666 that is substantially opposite to direction 664. Device 616 may be then manually gripped by the user and removed from connector 638.

FIG. 7 illustrates a particular embodiment of device 616 and of connector 638. However, any or all of devices 614, 618, 620 and 622 may include an electrical interface similar or identical to interface 640. Further, any or all of devices 614, 618, 620 and 622 may be connected to system 610 via a connector similar or identical to connector 638.

In the above embodiments, a mechanical lock-out feature was described in the form of a port being disposed on a rear face of a head unit such that the port is inaccessible when the head unit is installed in a dashboard. More generally, the port may be disposed rearward of the front face of the head unit to thereby be inaccessible when the head unit is installed in a dashboard. In another embodiment (not shown), a mechanical lock-out feature is in the form of a port being disposed behind a faceplate of a head unit, such as faceplate 146, such that the port is inaccessible when the faceplate is attached to the head unit. Thus, the lock-out feature may be unlocked by removing the faceplate from the head unit, which may require a special tool to thereby expose the port. The lock-out feature may again be locked by attaching or otherwise installing the faceplate on the head unit such that the port is covered by the faceplate.

Memory devices 14a, 14b have been described herein as being physically interchangeable. However, it is to be understood that it is within the scope of the invention for memory devices 14a, 14b to be physically different and not be physically interchangeable. For example, different types of memory devices may be used to store operating software and digital content.

Memory devices 14a, 14b have been described herein as being connected to ports 18, 20 via push-push type latching mechanisms. Each of memory devices 14a, 14b has also been described herein as being released from the respective push-push latch by manual pressure being directly applied to the memory device by a finger of the user. However, it is to be understood that it is within the scope of the invention for each of memory devices 14a, 14b to be released from the latch by the application of manual pressure to a release button rather than directly to the memory device. Further, it is within the scope of the invention for memory devices 14a, 14b to be connected to the ports other than by push-push latches. For example, memory devices 14a, 14b may be connected to the ports via simpler connectors that allow memory devices 14a, 14b to be inserted into the ports with single, uni-directional motions, and to be removed from the ports with single, uni-directional motions that are opposite to the directions of insertion.

Apparatus 112 has been disclosed herein as being an audio head unit that typically receives a memory device storing digital content in the form of music files. However, it is within the scope of the invention for the apparatus to be a multimedia-type of apparatus that receives a memory device storing many kinds of digital content, including audio content and video content.

While the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. An electronic system, comprising:
an electronic apparatus including a port having a restricted-access feature; and
a writeable memory device removeably connected to said port, said memory device being configured to updateably store operating software for said electronic apparatus.

2. The system of claim 1, wherein said electronic apparatus comprises an automotive audio head unit.

3. The system of claim 2, wherein said restricted-access feature comprises said port being inaccessible when said head unit is installed in a vehicle.

4. The system of claim 2, wherein said restricted-access feature comprises an electronic access code.

5. The system of claim 1, wherein said memory device comprises a secure digital memory card.

6. The system of claim 1, wherein said memory device is connected to said port without bonding.

7. The system of claim 1, wherein said memory device is configured to be removed from said port, rewritten with upgraded operating software, and reconnected to said port to thereby upgrade the operating software of said electronic apparatus.

8. A method of updating operating software of an electronic system, said method comprising:
providing an electronic apparatus including a port having a lock-out feature;
providing a first memory device connected to said port, said memory device storing first operating software for said electronic apparatus;
unlocking said lock-out feature;
disconnecting said memory device from said port;
connecting a second memory device to said port, said second memory device storing second operating software for said electronic apparatus; and
locking said lock-out feature.

9. The method of claim 8, comprising the further step, after said disconnecting step, of overwriting said first memory device with the second operating software, said second memory device comprising said first overwritten memory device.

10. The method of claim 8, comprising the further steps of:
receiving a request for updated features from a consumer of said electronic system, said receiving step occurring before said unlocking, disconnecting, connecting, and locking steps; and
selecting the second operating software corresponding to the requested updated features.

11. The method of claim 10, comprising the further step of writing the selected second operating software onto said second memory device.

12. The method of claim 8, wherein said lock-out feature comprises said port being inaccessible when said electronic apparatus is in an assembled and installed state.

13. The method of claim 8, wherein said lock-out feature comprises an electronic access code.

14. The method of claim 8, wherein said electronic apparatus comprises an automotive audio head unit.

15. The method of claim 14, wherein said unlocking step comprises exposing said port by at least one of:
removing said head unit from a dashboard in which said head unit is installed; and
removing a face plate of said head unit.

16. The method of claim 15, wherein said locking step comprises making said port inaccessible by one of:
installing said head unit in the dashboard; and
attaching said face plate to said head unit.

17. The method of claim 8, wherein each of said first memory device and said second memory device comprises a secure digital memory card.

18. An automotive audio head unit, comprising:
a processor;
a first electrical port in communication with said processor;
a first writeable memory storage medium electrically coupled to said port, said storage medium storing operating software for said head unit, said storage medium being physically inaccessible to a consumer of said head unit, said storage medium being accessible to, and replaceable by, a serviceman for upgrading the operating software;
a second electrical port in communication with said processor; and
a second writeable memory storage medium removeably coupled to said second port, said second storage medium storing audio content for playback by said head unit, said second storage medium being replaceable by the consumer of said head unit, said second storage medium being physically interchangeable with said first storage medium.

19. The head unit of claim 18, wherein each of said first storage medium and said second storage medium comprises a secure digital memory card.

20. The head unit of claim 18, wherein said first electrical port is disposed in a rear face of said head unit.

21. An automotive infotainment system, comprising:
an automotive audio/video head unit;
an electronic device in communication with said audio/video head unit and having at least one first terminal, said device defining a functionality of said audio/video head unit; and
a connector having at least one second terminal, each said second terminal being electrically connected to a corresponding said first terminal, said connector being configured to electrically connect said device to the system such that said device may be disconnected and removed from said connector exclusively by moving said device along a single axis, and such that an upgraded version of said device may be subsequently connected to said connector by pushing said upgraded version of said device along the axis and into engagement with said connector.

22. The system of claim 21, wherein each of said electronic device and said upgraded version of said device includes a secure digital input/output interface.

23. The system of claim 21, wherein said electronic device comprises one of a memory device, a universal serial bus interface, a global positioning system sensor, a global positioning system navigation engine, a Bluetooth compatible device, a camera, a wireless fidelity compatible device, and an AM/FM radio receiver.

24. An electronic system for installation in a vehicle and for use in the vehicle by a vehicle end user, said electronic system comprising:
an audio head including:
a housing;
a processor disposed within said housing; and
a first memory device port disposed on said housing and electrically coupled to said processor, said first memory device port being accessible from an exterior of said housing when said electronic system is uninstalled from the vehicle, said first memory device port being inaccessible by the end user when said electronic system is installed in the vehicle; and
a first memory device removably coupled with said first memory device port, said first memory device storing operating software for the operation of said processor.

25. The electronic system of claim 24 wherein said first memory device port comprises a slot in said housing.

26. The electronic system of claim 24 wherein said housing includes a front face exposed to the vehicle end user when said electronic system is installed in the vehicle, said audio head unit further including a second memory device port disposed on said front face of said housing and accessible from the exterior of said housing, said electronic system further comprising a second memory device removably coupled with said second memory device port, said second memory device storing digital content for playback by said processor.

27. The electronic system of claim 24 wherein said housing includes a front face exposed to the vehicle end user when said electronic system is installed in the vehicle, said first memory device port being disposed on said housing rearward of said front face.
